(19) United States
(12) Patent Application Publication
(10) Pub. No.: US 2009/0269453 A1
(43) Pub. Date: Oct. 29, 2009

(54) SYSTEM AND METHOD FOR PROCESSING GREEN ONIONS

(75) Inventors: David M. Cypher, JR., Yuma, AZ (US); Paul R. Valencik, JR., Yuma, AZ (US)

Correspondence Address: DUCKOR SPRADLING METZGER & WYNNE;A LAW CORPORATION, 3043 4th Ave., SAN DIEGO, CA, 92103, US

(73) Assignee: Fresh Innovations, LLC

(21) Appl. No.: 12/110,274

(22) Filed: Apr. 25, 2008

(51) Int. Cl. A23L 1/212; A23N 15/00

(52) U.S. Cl. 426/482; 99/637; 99/642; 99/643

(57) ABSTRACT

An embodiment of a system and method for processing green onions may include moving green onions along a path of travel, peeling at least one of the leaves from each green onion, aligning the root ends of the green onions, singulating the green onions, removing roots from the root ends of the green onions, and separating the green onions into groups based on the diameter of the root end of each green onion.

### FIELD OF THE INVENTION

The present invention relates in general to a system and method for processing vegetables, such as green onions. It more particularly relates to a system and method for green onion processing including cleaning and other processing steps in a continuous sequence in preparing the green onions for marketing them.

### BACKGROUND ART

There is no admission that the background art disclosed in this section legally constitutes prior art.

There have been techniques and equipment proposed for the preparation of freshly harvested vegetables, such as green onions, for sale to customers. Such techniques and equipment are designed to efficiently process large quantities of the product to facilitate delivery of the products to the market place. For example, reference may be made to U.S. Pat. Nos. 7,048,957 and 7,060,312, which disclose methods and apparatus for processing green onions by moving the green onions along a path of travel for skin peeling and root removal.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a diagrammatic plan view of a green onion processing system for preparing for the market place green onions according to an embodiment of the present invention;

FIG. 2 is a fragmentary detailed diagrammatic plan view of the embodiment of the system of FIG. 1;

FIGS. 3 and 4 are fragmentary enlarged pictorial views of an embodiment of a leaf removing station of the system of FIG. 2;

FIGS. 5 and 6 are fragmentary enlarged pictorial views of an embodiment of a leaf straightening station of the system of FIG. 2;

FIGS. 7 and 8 are fragmentary enlarged pictorial views of an embodiment of an aligning station of the system of FIG. 2;

FIGS. 9 and 10 are fragmentary enlarged pictorial views of an embodiment of a singulating and trash removal station of the system of FIG. 2;

FIGS. 11 and 12 are fragmentary enlarged pictorial views of an embodiment of a root removing station of the system of FIG. 2;

FIG. 13 is a diagrammatic greatly enlarged side view of an embodiment of the root removing station of the system of FIG. 2 showing the roots being removed from a green onion and employing a pair of water spray manifolds;

FIGS. 14-16 are fragmentary enlarged pictorial views of an embodiment of a sizing station of the system of FIG. 2;

FIG. 17 is a diagrammatic plan view of another embodiment of a system of processing green onion according to the present invention; and

FIGS. 18 and 19 are partial diagrammatic plan views of an embodiment of a sizing station of the system of FIG. 17.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

A system and method for processing green onions are disclosed. By utilizing an embodiment of the invention, freshly harvested vegetables such as green onions may have loose leaves removed, roots removed, and separated by the diameters of the root ends of the green onions in preparation for distribution.

In accordance with certain embodiments of the present invention, there is provided a method and system for processing green onions including moving a plurality of closely spaced green onions along a path of travel, peeling away at least one of the leaves from each green onion, aligning the root ends of the green onions, singulating the green onions to increase the distance between them, removing at least portions of the roots from the root ends of the green onions, and separating the green onions into groups based on the diameter of the root end of each green onion.

In accordance with another embodiment of the present invention, there is provided a system for processing green onions including devices for moving a plurality of closely spaced green onions along a path of travel, devices for peeling away at least one of the leaves from each green onion, devices for straightening the remaining leaves of the green onions, devices for aligning the root ends of the green onions, devices for singulating the green onions to increase the distance between them, devices for removing debris between the green onions, devices for removing at least portions of the roots from the root ends of the green onions, and devices for separating the green onions into groups based on the diameter of the root end of each green onion.

In accordance with yet another embodiment of the present invention, there is provided a system for processing green onions including a first horizontally disposed conveyor belt moving at a first speed for transporting the green onions, a first hold down belt for holding the green onions down on the first conveyor belt, a first water spray manifold for removing one or more leaves from the green onions, a second water spray manifold for straightening the leaf ends of the green onions, a paddle for tapping the leaf ends of the green onions to force the root ends of the green onions against a side-guard belt, a second conveyor belt moving at a second speed for singulating the green onions, the second speed being greater than the first speed, a second hold down belt for holding the green onions down on the second conveyor belt, at least one set of oppositely rotating meshing spur gears for removing roots from the root ends of the green onions, and a separating device for separating the green onions depending on the diameter of the root end of each green onion.

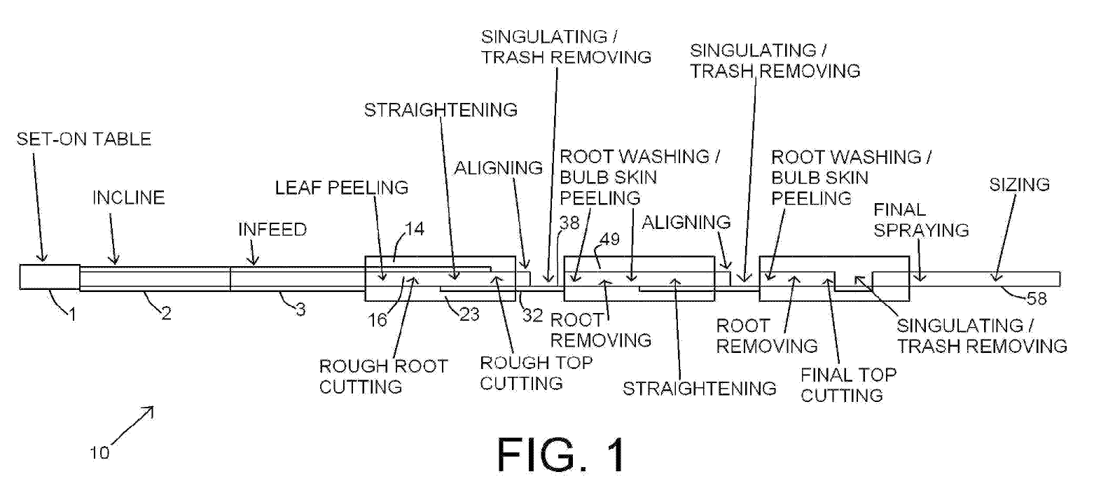

Referring to FIG. 1, a green onion processing system 10 is shown and includes a series of stations for processing vegetables such as green onions (not shown). In brief, a load of green onions from the field may be dumped manually or otherwise onto a set-on table 1. From the set-on table 1 the green onions may slide up an incline 2 to an infeeding station 3 where a pair of workers (not shown) may then correctly orient and place the green onions onto a conveyor belt 16 to be further processed as hereinafter described in greater detail.

The processing system 10 may begin by peeling off brown or loose leaves of the green onions at a leaf peeling station 14. Next the roots may be subjected to a rough cut to eliminate the longer portions of the roots. At a straightening station 23, the leaves of the green onions may then be straightened prior to the green onions undergoing a rough cut of their tops to make the lengths of the green onions substantially the same. The bulb or root ends of green onions may then be aligned at an aligning station 32 prior to being singulated or separated at a singulating and trash removal station 38. Trash or debris between the singulated green onions may then be removed. The root ends of the green onions may then be washed, and a layer of skin of the bulbs may be peeled off. The roots of the green onions may then be removed at a root removing station 49. The root ends of the green onions may again be washed, and another layer of skin of the bulbs may be peeled off. The leaf ends of the green onions may again be straightened to correct the orientation of each green onion.

The bulb or root ends of green onions may again be aligned prior to being singulated or separated for a second time. Any remaining trash or debris between the twice singulated green onions may then be removed. The root ends of the green onions may again be washed, and a layer of skin of the bulbs may be peeled off. Any remaining roots of the green onions may then be removed. The green onions may be singulated a third time, so that any remaining trash or debris may be removed. The green onions may then undergo a final spraying to clean the green onions. At a sizing station 58 cleaned green onions may finally be sized to separate the green onions into groups of green onions having root ends with similarly sized diameters.

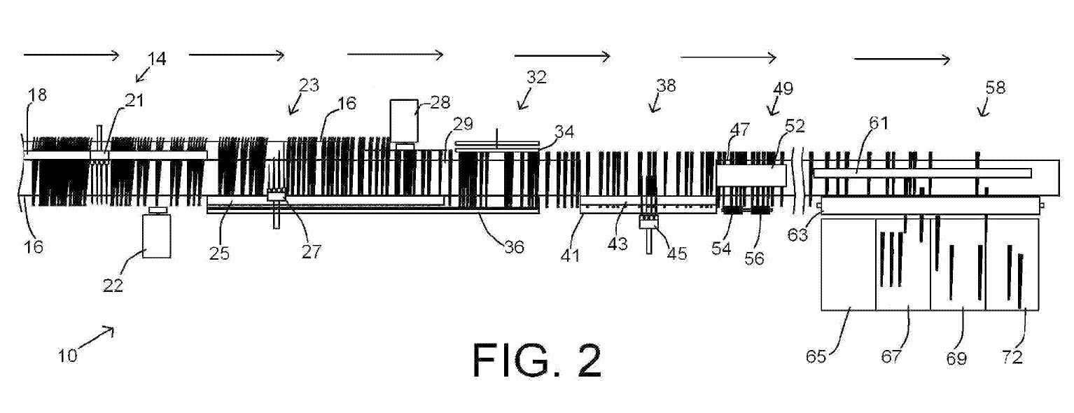

Referring now to FIG. 2, the system 10 may include a plurality of stations arranged sequentially for performing different operations on the green onions as they are moved continuously along a path of travel from left to right as viewed in the drawings. The onions are translated along the horizontal path of travel, and remain in a horizontal disposition throughout their entire course of travel. The green onions may be loaded into the apparatus 10 at a rate dependent upon the skill of a loader/operator (not shown) or by a suitable loading mechanism (not shown).

The loader may place the green onions on the horizontal conveyor belt 16 of the apparatus 10. The green onions may proceed through the leaf peeling station 14 at the conveyor belt 16 and may be held down on the conveyor belt 16 at their top leaf end by a hold down belt 18. As the green onions proceed through the leaf peeling station 14, a first water spray manifold 21 may direct a plurality of streams of water at the green onions at an oblique angle toward their root ends to peel off one or more undesirable leaves of the green onions. After proceeding past the first water spray manifold 21 of the leaf peeling station 14, the roots of the green onions may be rough cut by a rotating cutter 22 to remove the longer portions of the roots, which may make it easier to align the green onions later in the process.

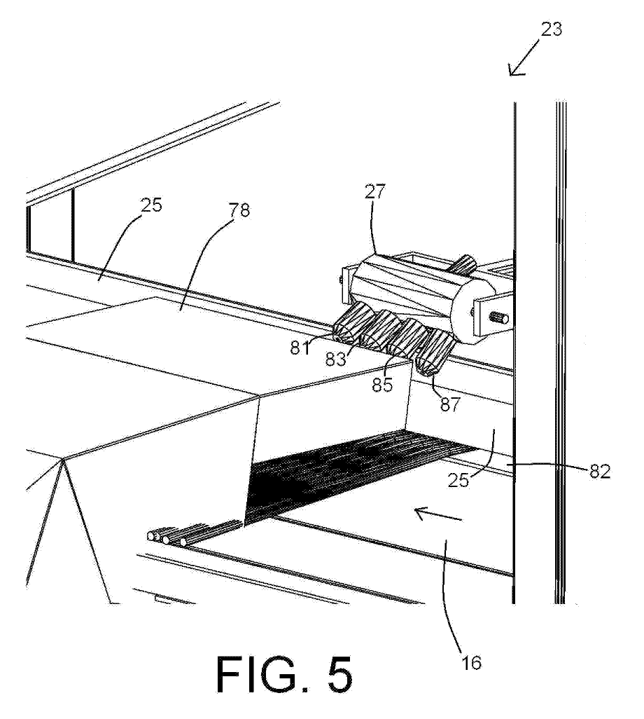

Upon exiting the leaf pealing station 14 after the rough cut of the roots, the green onions may then continue to be moved to the right via the conveyor belt 16 to transfer the onions onto another conveyor belt at the straightening station 23. Upon entering the straightening station 23, the hold down belt 18 holding down the top leaf end of the green onions may terminate, and a hold down belt 25 may begin holding down the root ends of the green onions to a lower conveyor belt 82 (FIG. 5). As the green onions proceed through the straightening station 23, a second water spray manifold 27 may direct a plurality of streams of water at the green onions at an oblique angle downwardly toward their top leaf ends to straighten or comb the leaves of the green onions.

After the leaves have been straightened by the second water spray manifold 27, a rotating cutter 28 may cut off a portion of the leaf ends of the green onions to give each of the green onions a similar length, which also may help in aligning the green onions later in the process.

Upon exiting the straightening station 23 at the cutting of the leaf end, the green onions may be transferred from the conveyor belt 16 to a narrower conveyor belt 29 that may not be as wide as conveyor belt 16 and enters the aligning station 32. While proceeding through the aligning station 32, the top leaf ends of the green onions may be tapped by a paddle 34 forcing the root ends of the green onions against a side-guard belt 36 to align the root ends of the green onions, which may position them properly for subsequently removing additional portions of the roots.

Upon being aligned in the alignment station 32, the green onions may remain on the conveyor belt 29 or transferred to another conveyor belt (not shown) to enter the singulating and trash removal station 38. Near the end of the conveyor belt 29 each green onion may be transferred to an entrance end of a conveyor belt 41 and a hold down belt 43 that supports green onions horizontally by their root ends only. The horizontal conveyor belt 41 may be moving faster than the conveyor belt 29 to singulate or separate the green onions further apart from one another. Singulating the green onions may increase the distance between adjacent green onions. After the green onions are singulated, a third water spray manifold 45 may direct a plurality of streams of water toward the top leaf ends of the green onions to remove any remaining trash or debris.

The singulated green onions may then be transferred from the conveyor belt 41 to a horizontal conveyor belt 47 to enter the root removing station 49. The conveyor belt 47 may be sized to allow the root ends of the green onions to extend past an end of the conveyor belt 47. The middle portions of the green onions may be pressed down on the conveyor belt 47 by a hold down belt 52 to hold the green onions in place on the conveyor belt 47 within the root removing station 49. As the green onions proceed through the root removing station 49, the extending root ends of the green onions may encounter one or more sets of rotating meshing spur gears 54, 56 to remove the long root hairs from the root ends of the green onions.

After proceeding past the last set of rotating spur gears 56, the green onion may remain on the conveyor belt 47 or may be transferred to another conveyor belt (not shown) to enter the sizing station 58. A hold down belt 61 may apply soft pressure to the top leaf portions of the green onions, while the extending root ends of the green onions encounter a pair of tapered opposing rollers 63 having a gap therebetween that gets smaller the further the root ends of the green onions proceed down the rollers. The green onions may be pulled by the rollers 63 and deposited into one of a plurality of sizing lanes 65, 67, 69, 72 depending on the diameter of the root end of each of the green onions.

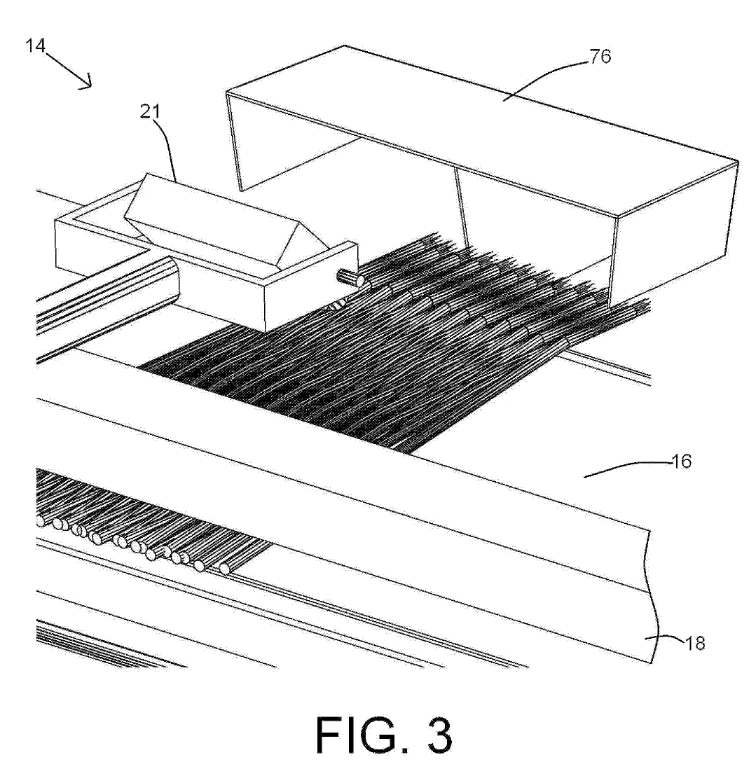

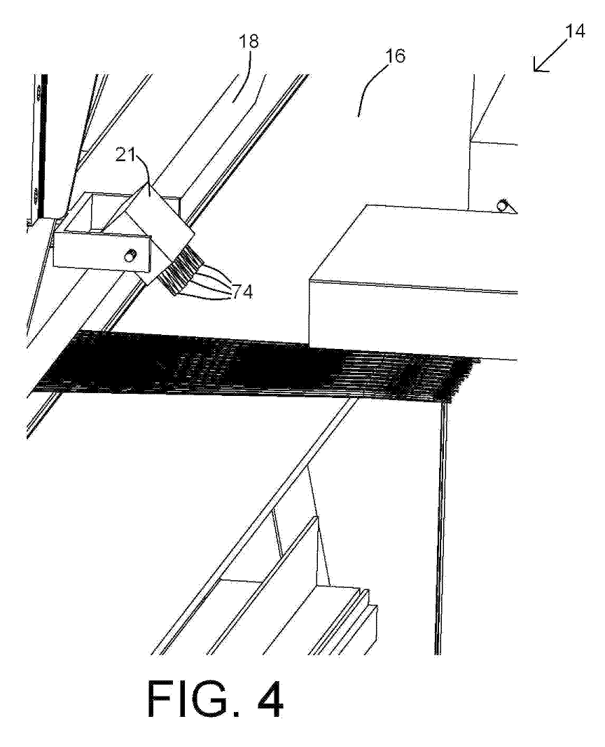

Referring now to FIGS. 3 and 4, the leaf peeling station 14 is shown in greater detail. The leaf peeling station 14 may include the horizontal conveyor belt 16 for transporting the green onions therethrough, the hold down belt 18 for holding top leaf portions of the green onions down on the conveyor belt 16, and the water spray manifold 21 for peeling off one or more leaves of the green onions. The water spray manifold 21 may include one or more nozzles 74 for directing a plurality of water streams at the green onions toward their root ends. The nozzles 74 may all be directed at similar angles toward the green onions. The hold down belt 18 may hold the green onions on the conveyor belt 16 to prevent the water streams from the water spray manifold 21 from pushing the green onions off the conveyor belt 16.

The leaf peeling station 14 may also include a water chute 76 to catch and direct the water and debris to a flume (not shown) beneath the leaf peeling station 14. The flume may extend substantially throughout the entire apparatus 10 and transport the water, leaves, trash, and other debris removed throughout the processing to a water reclamation station (not shown) to remove the leaves, trash, and other debris from the water and return the water to the apparatus 10 for re-use.

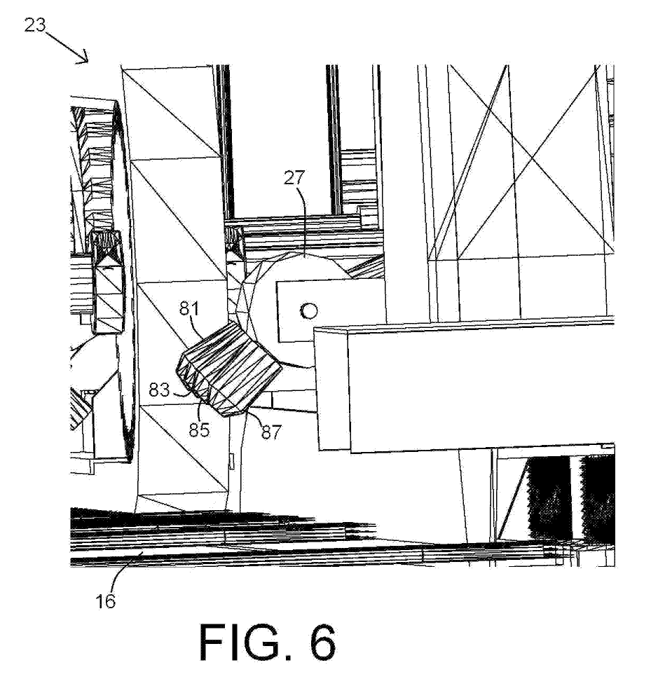

Referring now to FIGS. 5 and 6, the straightening station 23 is shown in greater detail. The straightening station 23 may include the conveyor belt 16 for transporting the green onions therethrough, the horizontal hold down belt 25 disposed above the belt 16 for holding root ends of the green onions down on the conveyor belt 16, and the water spray manifold 27 for straightening or combing the leaves of the green onions. The water spray manifold 27 may include one or more nozzles 81, 83, 85, 87 for directing a plurality of water streams at the green onions toward their leaf ends. The nozzles 81, 83, 85, 87 may be directed at slightly different angles to improve the effectiveness of the straightening the leaves of the green onions. The hold down belt 25 may hold the green onions on the conveyor belt 16 to prevent the water streams from the water spray manifold 27 from pushing the green onions off the conveyor belt 16. The straightening station 23 may also include a water chute 78 to catch and direct the water and debris to the flume described above regarding the leaf peeling station 14.

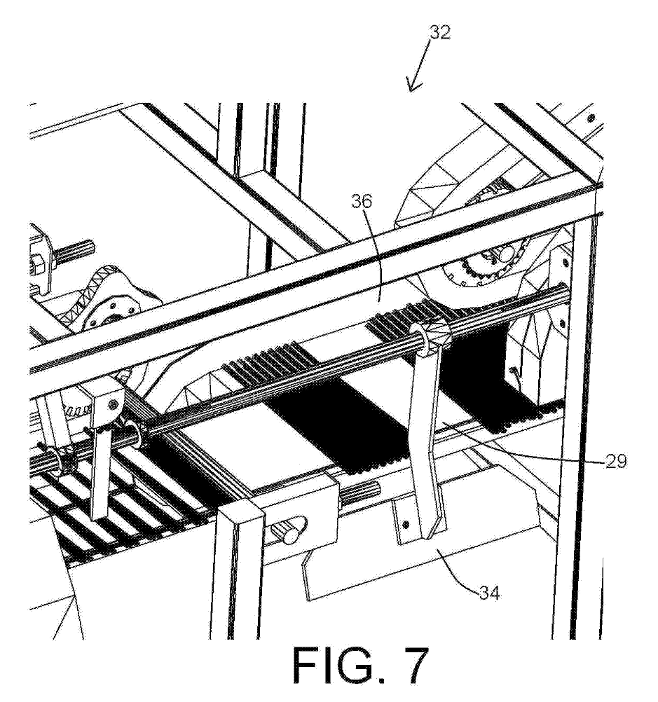

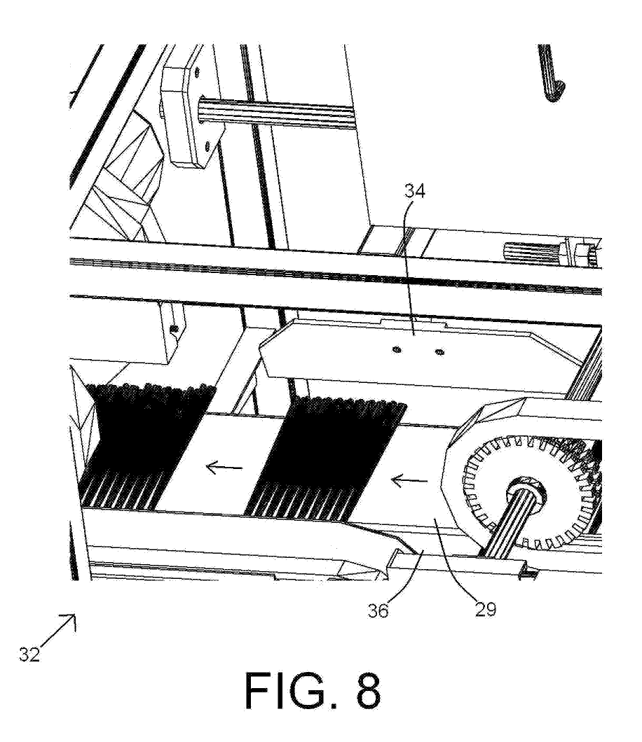

Referring now to FIGS. 7 and 8, the aligning station 32 is shown in greater detail. The aligning station 32 may include the horizontal conveyor belt 29 for transporting the green onions therethrough, a swinging paddle for tapping the leaf end of the green onions, and a side-guard belt 34 for aligning the root ends of the green onions as they are tapped against the belt 34. The conveyor belt 29 may be narrower than the previous conveyor belt 16 to allow both the leaf ends and the root ends of the green onions to extend beyond the edges of the conveyor belt 29. The paddle 32 may be elongated and controlled to periodically swing downwardly to engage abruptly the leaf ends of a plurality of green onions to force their root ends against the side-guard belt 34. The side-guard belt 34 may be moving at the same speed as the conveyor belt 29 to avoid any mis-alignment of the green onions. This alignment of the green onions may position the root ends in the desired position for removing portions of the roots.

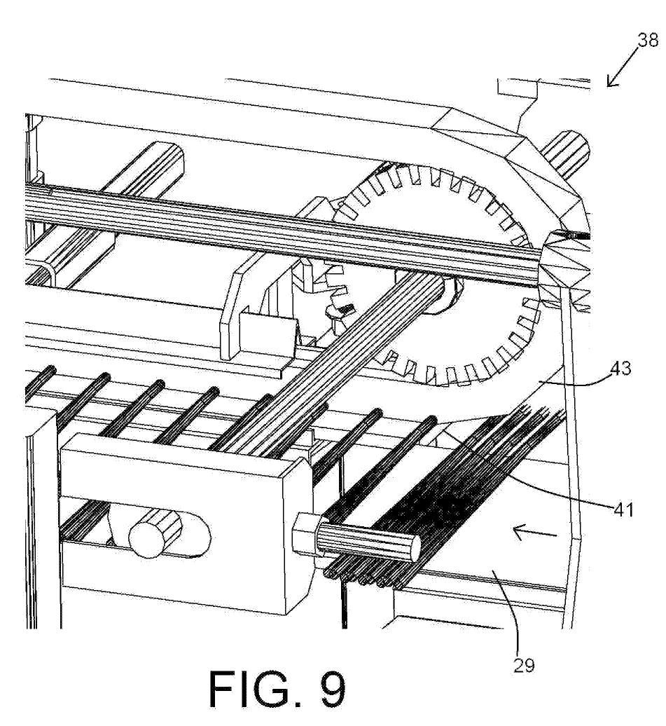

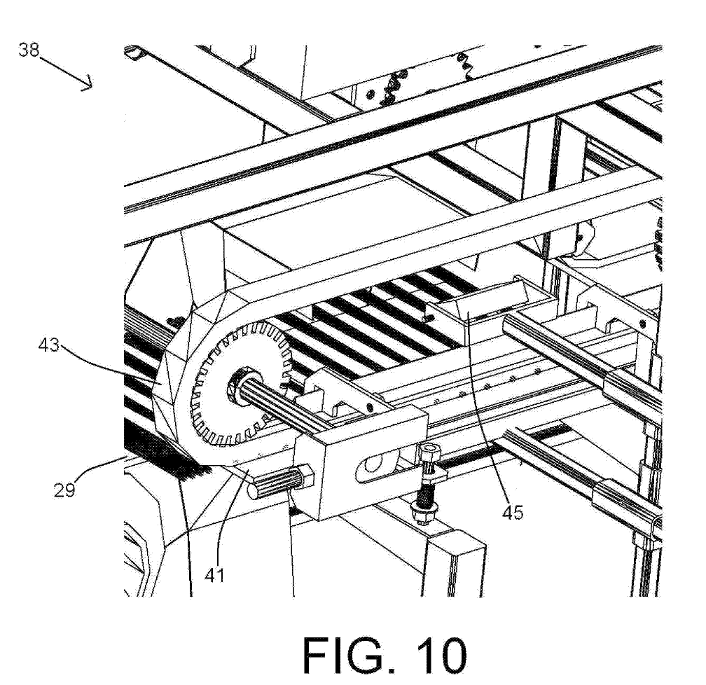

Referring now to FIGS. 9 and 10, the singulating and trash removing station 38 is shown in greater detail. The singulating and trash removing station 38 may include the conveyor belt 29 for transporting the green onions into and partially through the singulating and trash removal station 38, the horizontal conveyor belt 41 and the horizontal hold down belt 43 moving above the belt 41 for singulating and holding the root ends of the green onions, and the water spray manifold 45 for removing trash and debris from between the singulated green onions. The conveyor belt 29 moving at a first speed may transport the green onions to the conveyor belt 41 moving at a second faster speed. The second speed of the conveyor belt 41 may be greater than the first speed of the conveyor belt 29 to singulate or separate the green onions by increasing the distance between individual green onions. The conveyor belt 41 may be sufficiently narrow such that only the root ends of the green onions may be supported by the conveyor belt 41. The hold down belt 43 may be similarly sized to hold down the root ends of the green onions to the conveyor belt 41.

The water spray manifold 45 may be disposed above the green onions and may direct a plurality of water streams at the green onions toward their leaf ends to remove trash and debris located between the singulated green onions and to straighten the green onions. Another water spray manifold (not shown) may be disposed below the green onions and may also direct a plurality of water streams at the green onions toward their leaf ends to remove trash and debris located between the singulated green onions and to straighten the green onions. The green onions may be singulated to allow for the removal of trash and debris therebetween, but also to improve the effectiveness of the root removing.

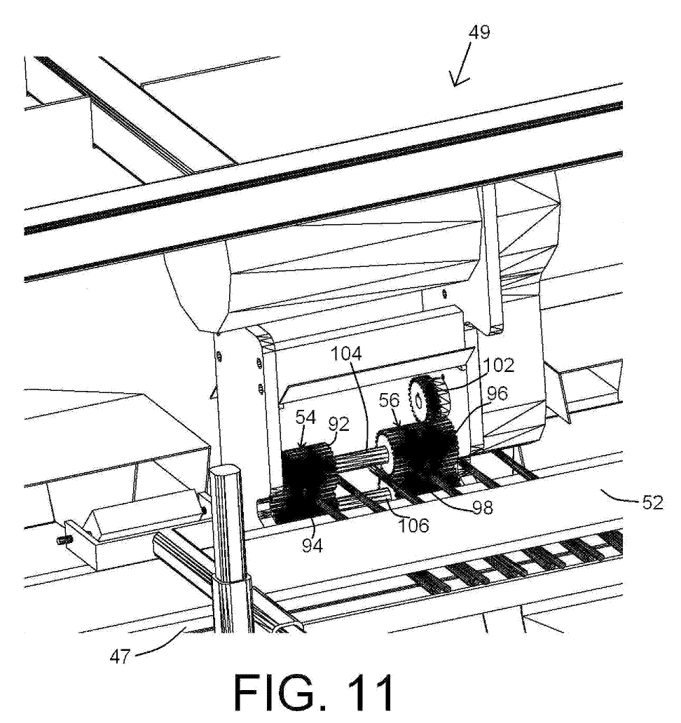

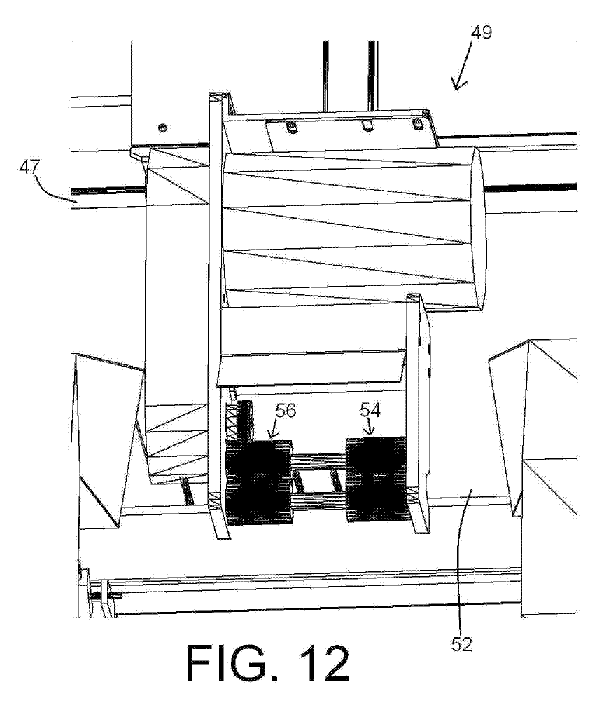

Referring now to FIGS. 11 through 13, the root removing station 49 is shown in greater detail. The root removing station 49 may include the horizontal conveyor belt 47 for transporting the green onions therethrough, a pair of oppositely rotating spur gear sets 54, 56 for removing portions of the roots of the green onions, a hold down belt 52 for holding the green onions down to the conveyor belt 47, and a pair of water spray manifolds 55, 57. The conveyor belt 47 may have a width sufficient to support substantially the entire length of the green onions with only the root ends of the green onions extending beyond an edge of the conveyor belt 47.

As described previously, the root ends of the green onions may have been positioned in the aligning station 32 into the desired position so that conveyor belt 47 moves the root ends of the green onions adjacent the rotating meshing spur gear sets 54, 56 for effectively removing portions of the roots of the green onions. The hold down belt 52 may have a width sufficient to hold approximately a middle third of the green onions down to the conveyor belt 47. The water spray manifold 55 may be disposed above the green onions and may direct a plurality of streams of water under pressure downwardly and angularly toward the rotating spur gear sets 54, 56 to assist in directing the root hairs into the rotating spur gear sets 54, 56 and in keeping the rotating spur gear sets 54, 56 clean. A water spray manifold 57 may be disposed below the green onions and may direct a plurality of streams of water under pressure upwardly and angularly toward the rotating spur gear sets 54, 56 to also assist in directing the root hairs into the rotating spur gear sets 54, 56 and in keeping the rotating spur gear sets 54, 56 clean. A water spray manifold (not shown) may be disposed to the right of the gear sets 54, 56 to direct water under pressure thereagainst for cleaning it from the separated debris.

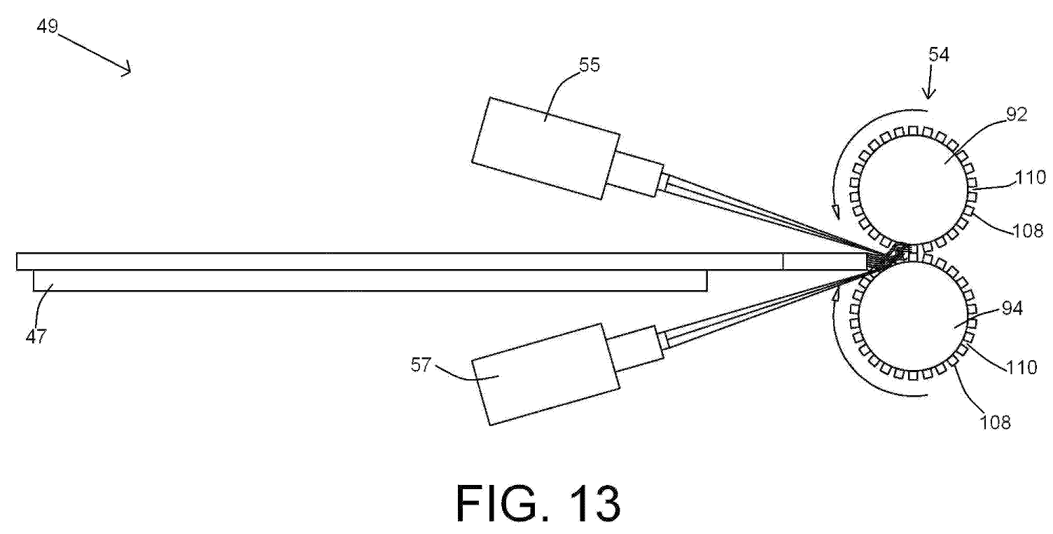

The rotating spur gear sets 54, 56 may include a pair of rotating meshing spur gears 92 and 94, 96 and 98, respectively, all driven by a gear 102 powered by a single motor (not shown). The spur gear 92 may be connected to the spur gear 96 via a connecting rod 104, while the spur gear 94 may be connected to the spur gear 98 via a connecting rod 106 to avoid the need for a second motor. The spur gear sets 54, 56 may be substantially identical, therefore only spur gear set 54 will be described as shown in FIG. 13. Each spur gear 92, 94 of the spur gear set 54 may include a plurality of teeth 108 having a plurality of gaps 110 therebetween.

The teeth 108 and gaps 110 may be sized to permit the introduction of the root hairs between the spur gears 92, 94 and to reject the introduction of the root end therebetween by having the size of the gaps 110 substantially less than the desired diameter of the root end of the green onions. Therefore, even in the case of a improperly aligned green onion, one that may be too close to the rotating gear set, the root end of the green onion may merely be displaced at an angle by the rotating gear set without destroying the root end of the green onion. In this regard, the flexible onions simply flex as they have their roots removed, without having their root bulbs enter the meshing gear teeth.

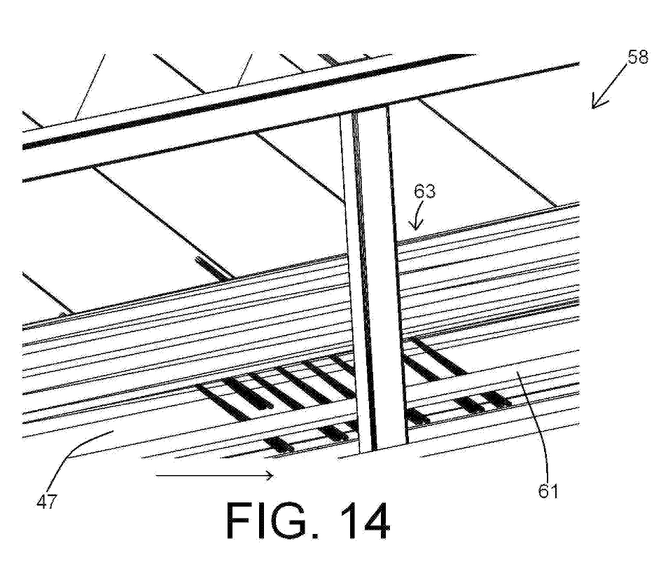

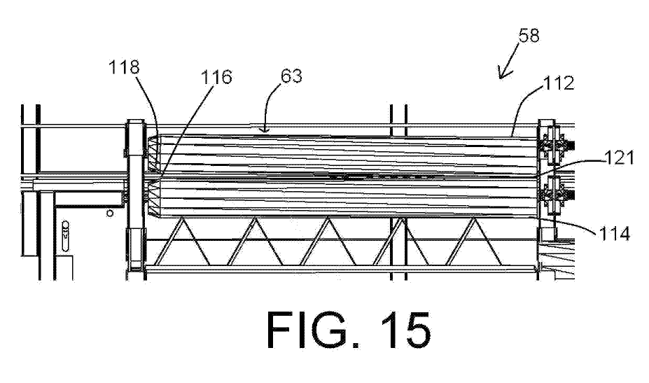

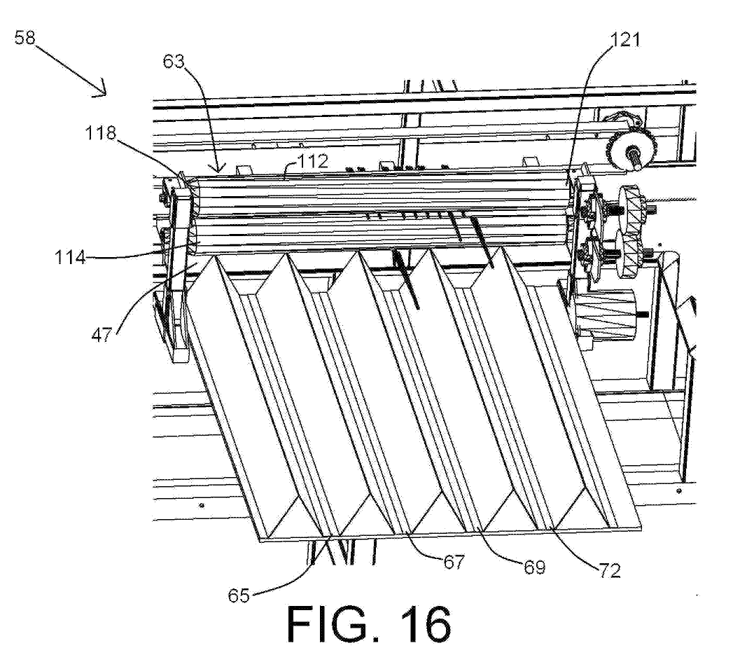

Referring now to FIGS. 14 through 16, the sizing station 58 is shown in greater detail. The sizing station 58 may include the conveyor belt 47 for transporting the green onions therethrough, the hold down belt 61 for holding down with soft pressure a portion of the leaf ends of the green onions on the conveyor belt 47, the roller set 63 having a pair of oppositely rotating rollers 112, 114, and a plurality of sizing lanes 65, 67, 69, 72. The rollers 112, 114 may be manufactured of a soft material to allow them to grab the root ends of the green onions without damaging them.

The roller set 63 may include a tapered gap 116 between the rotating pinch rollers 112, 114. The gap 116 may be at an initially desired distance at an entrance end 118 of the roller set 63 where the green onions are first introduced to the roller set 63, and then tapered throughout the length of the roller to conclude at a significantly smaller distance, than the initially desired entrance end distance, at an opposite end 121 of the roller set 63.

The tapered gap 116 may allow the sorting of the green onions depending on the diameter of the root end of the individual onions. The green onions with the larger diameter root ends may be deposited into sizing lane 65, while the green onions with smallest desired diameter root ends may be deposited into size lane 72 with the green onions with root end diameters between these sizes being deposited into one of the other two sizing lanes 67, 69. Green onions with root end diameters less than the smallest desired diameter may proceed down the conveyor belt 47 to be discarded.

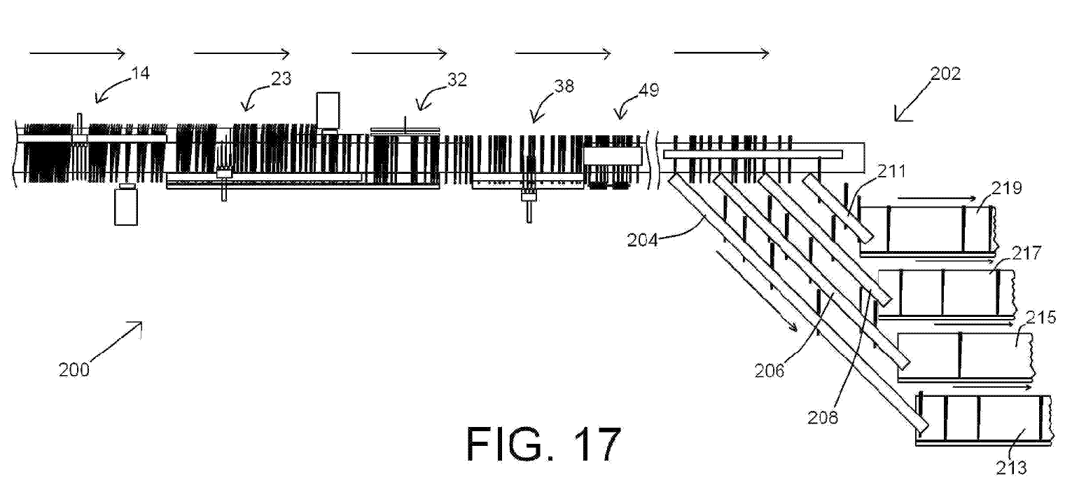

Referring now to FIG. 17, another embodiment of an apparatus for processing green onions according to the present invention, generally referenced as 200, is shown. The apparatus 200 may include a plurality of stations substantially identical to the stations described for apparatus 10, except that the sizing station 58 may be replace with a sizing station 202. The sizing station 202 may include a plurality of oppositely rotating belt sets 204, 206, 208, 211 for sorting the green onions depending on the diameters of the root ends of the green onions, and a plurality of corresponding conveyor belts 213, 215, 217, 219, respectively, for transporting the sorted green onions.

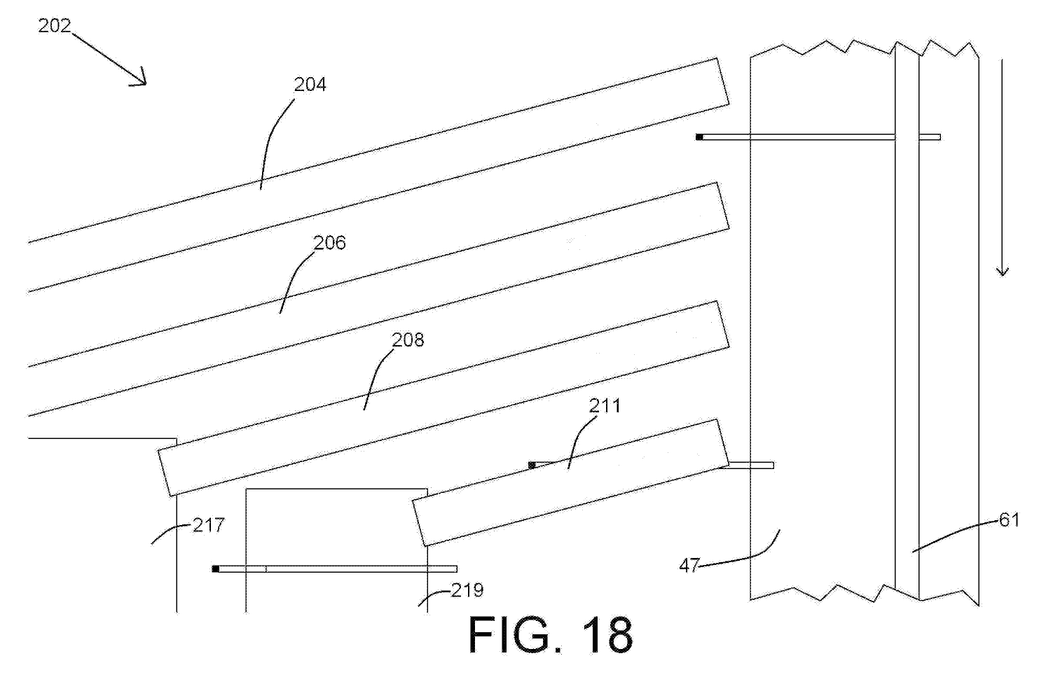

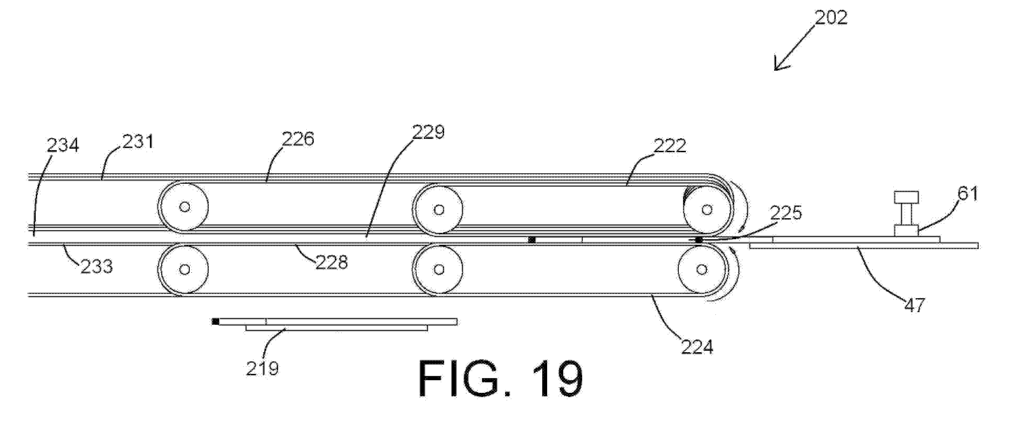

Referring now to FIGS. 17-19, the sizing station 202 is shown in greater detail. The sizing station 202 may include the conveyor belt 47 for transporting the green onions therethrough, the hold down belt 61 for holding down with soft pressure a portion of the leaf ends of the green onions on the conveyor belt 47, the rotating angularly disposed belt sets 204, 206, 208, 211, and the conveyor belts 213, 215, 217, 219.

Each of the rotating belt sets may include a gap therebetween of differing size and a differing length to deposit the sorted green onions to their appropriate conveyor belt. The rotating belt set 211 may include a pair of oppositely rotating belts 222, 224 having a desired gap 225 therebetween. Since rotating belt set 211 may be the last belt set encountered by the root ends of the green onions as they are transported on conveyor belt 47, the gap 225 may be the smallest in size of all of the belt sets.

The rotating belt set 208 may include a pair of oppositely rotating belts 226, 228 having a desired gap 229 therebetween. The gap 229 may be larger in size than the gap 225 of the rotating belt set 211. Likewise, the rotating belt set 206 may include a pair of oppositely rotating belts 231, 233 having a desired gap 234 therebetween. The gap 234 may be larger in size than the gap 229 of the rotating belt set 208. Though not shown in the drawings, the gap between the rotating belts of rotating belt set 204 may be larger in size than the gap 234 of rotating belt set 206.

As described above, the size of the gap between the individual belt sets may decrease as the green onions proceed through the sizing station 202, so that the green onions with the largest diameter root ends may be sorted out first by the rotating belt set 204 and deposited on conveyor belt 213, the green onions with the next largest diameter root ends may be sorted out next by the rotating belt set 206 and deposited on conveyor belt 215, and so forth. The rotating belt sets may be aligned at an oblique angle with the conveyor belt 47 to allow the green onions to be grabbed by the appropriate rotating belt set even though the diameter of the root end of the green onion is larger than the gap between the appropriate rotating belt set. The belts in these rotating belt sets may be manufactured of a soft material to enable them to grab the root ends of the green onions without damaging them.

Words such as “about,” “approximately” or other such words as used herein shall be defined to mean a tolerance of plus or minus 20 percent.

While particular embodiments of the present invention have been disclosed, it is to be understood that various different modifications are possible and are contemplated within the true spirit and scope of the appended claims. There is no intention, therefore, of limitations to the exact abstract or disclosure herein presented.

What is claimed is:

1. A method of processing green onions each having a root end and a leaf end with a plurality of leaves, comprising;
moving a plurality of closely spaced green onions along a path of travel;
peeling away at least one of the leaves from each green onion;
straightening the remaining leaves of the green onions;
aligning the root ends of the green onions;
singulating the green onions to increase the distance between them;
removing debris between the green onions;
removing at least a portion of the roots from the root ends of the green onions; and
sorting the green onions into groups based on the diameter of the root end of each green onion.

2. The method according to claim 1, further including transporting the green onions in a horizontal position on two or more conveyor belts.

3. The method according to claim 2, further including holding the green onions down against the conveyor belts using at least one hold down belt.

4. The method according to claim 1, wherein the peeling includes spraying the green onions with a water spray at an oblique angle toward the root ends of the green onions.

5. The method according to claim 1, further including cutting off a portion of the roots at the root ends of the green onions.

6. The method according to claim 1, wherein the straightening includes spraying the green onions with a water spray at an oblique angle toward the leaf ends of the green onions.

7. The method according to claim 6, further including cutting off a portion of the leaf ends of the green onions.

8. The method according to claim 1, wherein the aligning includes tapping on the leaf ends of the green onions to force the root ends of the green onions against a side-guard belt.

9. The method according to claim 1, wherein the singulating includes transferring the green onions from a first conveyor belt moving at a first speed to a second conveyor belt moving at a second speed, the second speed being greater than the first speed.

10. The method according to claim 1, wherein the removing debris includes spraying the green onions with a water spray at an oblique angle toward the leaf ends of the green onions.

11. The method according to claim 1, wherein the removing roots includes transporting the root ends of the green onions adjacent at least one set of oppositely rotating spur gears having teeth spaced apart by a predetermined distance substantially less than the diameter of a desired root end.

12. The method according to claim 11, wherein the removing roots includes directing a first water spray from above green onions toward the rotating spur gears and a second water spray from below the green onions toward the rotating spur gears to assist in directing the roots of the green onions into the spur gears and to assist in keeping the spur gears clean.

13. The method according to claim 1, wherein the sorting includes introducing the root ends of the green onions into a pair of oppositely rotating rollers having a tapering gap.

14. The method according to claim 1, wherein the sorting includes introducing the root ends of the green onions to a plurality of sets of oppositely rotating belts having varying sized gaps therebetween.

15. The method according to claim 1, further including;
rough cutting the roots of the green onions to remove longer portions of the roots;
rough cutting the leaf ends of the green onions so that the green onions have substantially similar lengths;
washing the root ends of the green onions;
peeling away a layer of skin from each bulb at the root ends of the green onions;
re-washing the root ends of the green onions subsequent removing at least portions of the roots;
peeling away another layer of skin from each bulb at the root ends of the green onions;
straightening the green onions subsequent removing at least portions of the roots;
re-aligning the root ends of the green onions;
singulating the green onions a second time;
removing debris between the green onions subsequent the second singulation;
re-washing the root ends of the green onions subsequent singulating the green onions a second time;
peeling away another layer of skin from each bulb at the root ends of the green onions subsequent singulating the green onions a second time;
removing at least a portion of the roots remaining on the root ends of the green onions;
final cutting the leaf ends of the green onions; and
spraying the green onions with water for cleaning the green onions.

16. A system for processing green onions each having a root end and a leaf end with a plurality of leaves, comprising:
means for moving a plurality of closely spaced green onions along a path of travel;
means for peeling away at least one of the leaves from each green onion;
means for straightening the remaining leaves of the green onions;
means for aligning the root ends of the green onions;
means for singulating the green onions to increase the distance between them;
means for removing debris between the green onions;
means for removing at least a portion of the roots from the root ends of the green onions; and
means for sorting the green onions into groups based on the diameter of the root end of each green onion.

17. A system for processing green onions each having a root end and a leaf end with a plurality of leaves, comprising:
a first horizontally disposed conveyor belt moving at a first speed for transporting the green onions;
a first hold down belt for holding the green onions down on the first conveyor belt;
a first water spray manifold for removing one or more leaves from the green onions;
a second water spray manifold for straightening the leaf ends of the green onions;
a paddle for tapping the leaf ends of the green onions to force the root ends of the green onions against a side-guard belt;
a second conveyor belt moving at a second speed for singulating the green onions, the second speed being greater than the first speed;
a second hold down belt for holding the green onions down on the second conveyor belt;
at least one set of oppositely rotating spur gears for removing roots from the root ends of the green onions; and
a sorting device for sorting the green onions depending on the diameter of the root end of each green onion.

18. The system according to claim 17, further including a cutting device for cutting a portion of the roots at the root ends of the green onions.

19. The system according to claim 17, further including a cutting device for cutting a portion of the leaf ends of the green onions.

20. The system according to claim 17, wherein the second water spray manifold includes a plurality nozzles directing water sprays at different angles.

21. The system according to claim 17, further including a third water spray manifold disposed above the green onions and directing a spray of water at the rotating spur gears and a fourth water spray manifold disposed below the green onions directing a spray of water at the rotating spur gears to assist in directing the roots of the green onions into the rotating spur gears and keeping the rotating spur gears clean.

22. The system according to claim 17, wherein the sorting device includes a pair of oppositely rotating rollers having a tapering gap therebetween.

23. The system according to claim 17, wherein the sorting device includes a plurality of sets of oppositely rotating belts having differing gaps therebetween.

24. An apparatus for removing at least a portion of roots of green onions, comprising:
at least one set of oppositely rotating spur gears;
the spur gears having teeth spaced apart by a predetermined distance substantially less than the diameter of a desired root end of the green onions;
a conveyor belt for transporting root ends of the green onions adjacent the spur gears;
a first water spray manifold disposed above the green onions and directing a spray of water at the rotating spur gears; and
a second water spray manifold disposed below the green onions and directing a spray of water at the rotating gears.

25. The apparatus according to claim 24, further including an alignment device having a paddle that taps leaf ends of the green onions to force root ends of the green onions against a side-guard belt.

26. An apparatus for sorting green onions having root ends, comprising
a sorting device for sorting the green onions depending on the diameter of a root end of each green onion; and
a conveyor belt for transporting the green onions adjacent the sorting device.

27. The apparatus according to claim 26, wherein the sorting device includes a pair of oppositely rotating rollers having a tapering gap therebetween.

28. The apparatus according to claim 26, wherein the sorting device includes a plurality of sets of oppositely rotating belts having differing gaps therebetween.
